(19) United States
(12) Patent Application Publication
(10) Pub. No.: US 2012/0214931 A1
(43) Pub. Date: Aug. 23, 2012

(54) METHOD FOR INCORPORATING SOLIDS INTO POLYMERS

(75) Inventors: Udo Dünger, Leverkusen (DE); Thomas König, Leverkusen (DE)

(73) Assignee: Bayer MaterialScience AG, Leverkusen (DE)

(21) Appl. No.: 13/394,095

(22) PCT Filed: Sep. 1, 2010
(86) PCT No.: PCT/EP2010/062790

§ 371 Date: May 4, 2012

(30) Foreign Application Priority Data
Sep. 4, 2009 (DE) 10 2009 040 047.8

(51) Int. Cl. C08K 3/04; C08L 77/00; C08L 69/00; B82Y 30/00

(52) U.S. Cl. 524/496; 524/612; 524/606; 977/742

(57) ABSTRACT

The invention relates to a method for incorporating solids into polymers by means of a tightly meshing twin-screw or multi-screw compounder for producing a polymer composite material. The method according to the invention is especially used to incorporate solids, such as carbon nanotubes, that significantly increase the viscosity in the polymer melt.

The invention relates to a process for incorporating solids into polymers by means of a tightly meshing twin- or multi-shaft machine in order to produce a polymer composite. The process according to the invention is used in particular for incorporating solids which result in a pronounced increase in viscosity in the polymer melt, such as, for example, carbon nanotubes.

In order to meet the constantly increasing demands that are made of materials nowadays, continual further development of the material properties is necessary.

In the field of polymers, the properties of base polymers are increasingly being deliberately changed by the addition of additives and/or other polymers. This so-called compounding to produce a plastics moulding composition (the compound) takes place using the plastics raw materials, which are usually melted, and with the addition and incorporation of fillers and/or reinforcing materials, plasticisers, adhesion promoters, lubricants, stabilisers, dyes, etc. The preparation frequently also includes the removal of volatile constituents, such as, for example, air and water. The preparation can also comprise a chemical reaction, such as, for example, grafting, modification of functional groups or modification of the molecular weight by deliberately increasing or reducing the molecular weight.

Nowadays, compounding is in most cases carried out in co-rotating twin-screw extruders. In the production and processing of polymers, screw machines based on the principle of precisely abrading profiles have found a variety of uses. This is based especially on the fact that polymer melts adhere to surfaces and, under conventional processing temperatures, degrade over time, which is suppressed by the self-cleaning action of the abrading screws. Such tightly meshing screw extruders are described, for example, in textbook [1] ([1] =Kohlgrüber. Der gleichläufige Doppelscheckenextruder, Hanser Verlag Munich 2007), which explains in detail in particular the construction, function and operation of twin- and multi-shaft extruders. Modern screw extruders have a modular design in which various screw elements can be attached to a core shaft. The person skilled in the art is thereby able to adapt the screw extruder to the process task in question.

A screw extruder for incorporating solids into polymers has process zones arranged in series, which are explained, for example, in [1] on pages 61-75. In the intake zone, the plastics raw materials and/or the additives are introduced into the extruder. In the plastification zone or melting zone, the transition from the solid polymer to the molten state takes place. Highly viscous or solid additives effect increased energy dissipation as a result of internal and external friction, which accelerates the formation of the melt film necessary for plastification but at the same time can also lead to overheating of the viscous phase.

The melt conveying zones in extruder screws serve to transport the product from one process zone to the next and to take in fillers. Melt conveying zones are generally partly filled, such as, for example, in the case of transport of the product from one process zone to the next, in the case of degassing and in residence-time zones. The energy required for conveying is dissipated and manifests itself in a disadvantageous manner in an increase in the temperature of the polymer melt. Screw elements that dissipate as little energy as possible should therefore be used in a conveying zone. For pure melt conveying, threaded elements having thread pitches of typically from 0.5 to twice the inside diameter of the extruder barrel D (also abbreviated hereinbelow to extruder diameter D or diameter D) are conventional.

Upstream of pressure consumers inside the extruder, such as, for example, reverse-conveying elements, mixing elements, reverse or neutral kneading blocks, and upstream of pressure consumers outside the extruder, such as, for example, die bases, extrusion tools and melt filters, a back-pressure zone forms inside the extruder, in which conveying is effected with complete filling and in which the pressure for overcoming the pressure consumer must be built up. The pressure build-up zone of an extruder, in which the pressure necessary to discharge the melt is produced, is referred to as the discharge zone.

The energy introduced into the polymer melt splits into effective power for pressure build-up and for conveying the melt, and dissipation power, which manifests itself in a disadvantageous manner as an increase in the temperature of the melt. In the pressure build-up zone, there is a considerable backwards flow of the melt over the screw crests, and consequently an increased energy input. Screw elements that dissipate as little energy as possible should therefore be used in a pressure build-up zone.

It is known to the person skilled in the art that a particularly large amount of energy is dissipated in the melt in the region of the screw crests, which results locally in considerable overheating in the product. This is shown, for example, in [1] on pages 160ff for a double-threaded conveying element having the known Erdmenger screw profile. Such local overheating can lead to damage in the product, such as, for example, a change in the odour, colour, chemical composition or molecular weight, or to the formation of inhomogeneities in the product, such as gel bodies or pinholes.

In order to increase the economy of the compounding, the available drive powers, torques and speeds increase constantly (see [1] pages 59-60). In particular, the increasing throughputs necessitate an increase in the screw speed, which leads to higher thermal and mechanical polymer stress. This increases the risk of loss of product quality due to a decrease in the molar mass, thermal inhomogeneities and melting problems. According to textbook [1], constant optimisation and adaptation of the extruder and screw concepts are necessary in order to avoid this risk.

The risk of product damage due to thermal stress during compounding occurs in particular when incorporating solids which cause a pronounced viscosity increase in the polymer melt, such as, for example, talc, lime, chalk, titanium dioxide, iron oxide, organic or inorganic pigments, barium sulfate, carbon blacks or carbon nanotubes (CNTs).

The last-mentioned carbon nanotubes additionally have the property of forming agglomerates, which must be broken up in order to obtain as homogeneous a distribution as possible of the nanoparticles in the composite (A. Kwade, C. Schilde, Dispersing Nanosized Particles, CHEManager Europe 4 (2007), page 7). CNT agglomerates can be broken up by introducing shear forces into the dispersion (WO1994/23433A1). A minimum dispersion stress is therefore necessary in order to achieve homogeneous distribution and accordingly optimum product properties (see also DE102008038523.9).

As is known to the person skilled in the art, the thermal and mechanical stress on the conveyed material increases as the ratio of the extruder length L to the extruder diameter D (L/D ratio) of the screw extruder used increases, the L/D ratio of the intake zone being unimportant for the thermal and mechanical stress. It would be possible, for example, to design a very long intake and/or conveying zone, in which only polymer below the melting point and/or solids are conveyed, without an appreciable stress being placed on the conveyed material. Critical for the stress on the conveyed material is the Lₘₑₗₜ/D ratio in the process part of the extruder that is wetted with melt, having the melt-wetted length Lₘₑₗₜ. Here and in the following, the melt-wetted length L,ₘₑₗₜ refers to the length of the extruder from the start of the melting zone. The melting zone usually begins with the first kneading block. The melt-wetted length Lₘₑₗₜ is usually equal to the overall length Lₒᵥₑᵣₐₗₗ minus the length of the intake zone.

In order to achieve a dispersing task optimally, a minimum Lₘₑₗₜ/D ratio of the melt-wetted process part appears to be necessary according to the prior art.

WO2009/000408A1 describes a process for the production of a conductive polymer composite containing carbon nanotubes, in which a thermoplastic polymer in solid phase is conveyed together with the carbon nanotubes to the main intake of a twin-shaft co-rotating screw extruder, and the carbon nanotubes are predispersed in the intake zone by solids friction to form a solids mixture. In a subsequent melting zone, the polymer is melted. In the melting zone, the carbon nanotubes are predominantly dispersed further by hydrodynamic forces and are distributed homogeneously in the polymer melt in further zones.

In the exemplary embodiments, Lₒᵥₑᵣₐₗₗ/D ratios in the range from 27.2 to 36.0 and Lₘₑₗₜ/D ratios in the range from 19.5 to 28.2 are disclosed (see also Table 1). The energy inputs indicated in WO2009/00408A1 are comparatively high (see Table 1).

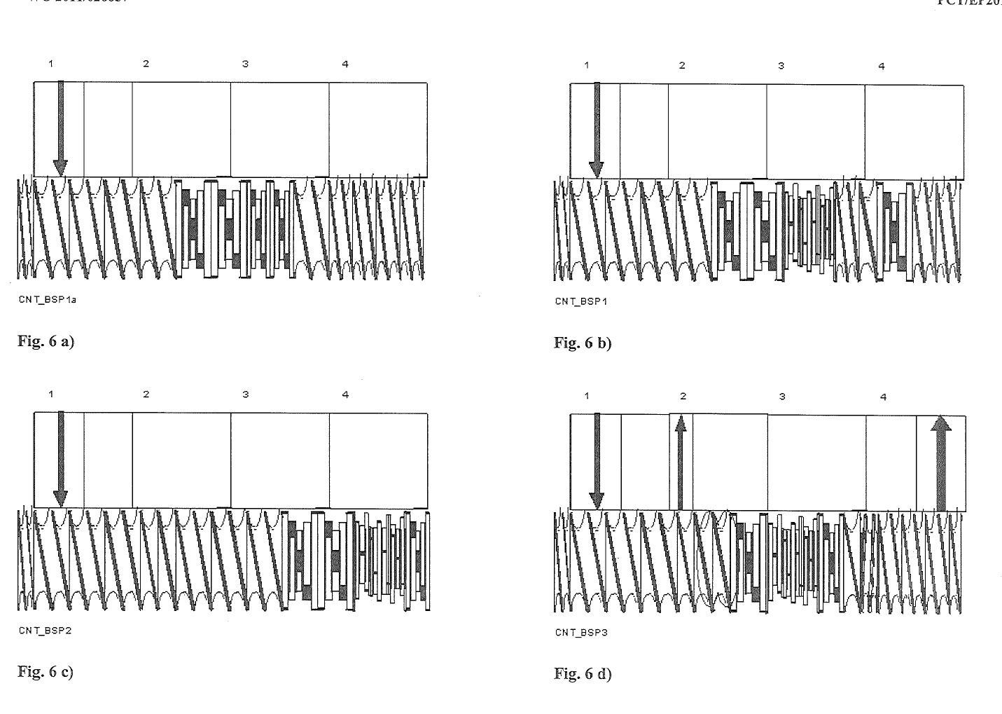

On page 79 of [1], a twin-screw extruder for incorporating glass fibres into polyamide is shown by way of example (FIG. 4.24). As can be seen from the figure, the characteristic Lₒᵥₑᵣₐₗₗ/D ratio in this case is 28. The screw structure consists of 6 barrels, the intake zone being about 1.4 barrels long. A value of 21.5 is accordingly obtained for the Lₘₑₗₜ/D ratio (from the first kneading block to the end of the shaft). Because glass fibres must be incorporated particularly gently (see, for example, Johannaber, Michaeli, Handbuch SpritzgieBen, 2nd edition, Hanser Verlag Munich 2004, p. 385ff), this is an example of a particularly gentle extruder screw and therefore lies at the bottom limit of the melt-wetted process lengths of co-rotating extruders which are used according to the prior art.

According to the prior art, the minimum Lₘₑₗₜ/D ratio accordingly appears to be above 19.

In order to keep the thermal and mechanical stress within acceptable limits and not reduce the polymer properties too greatly by thermal degradation, it is necessary according to the prior art to reduce the speed and accordingly the throughput, but this has a negative effect on the space-time yield and accordingly on the economy and energy efficiency of the process. For example, the throughputs in the process described in WO2009/000408A1 are in the range of only from 3 to 26 kg/h. The maximum throughputs of from 5 kg/h (Example 2B) to 9.1 kg/h (Example 2A) achieved in document WO1994/023433 Al are also comparatively low for a compounding process (see also Table 2).

The throughputs are naturally dependent on the extruder size used. A process in a small multi-shaft extruder can ideally be scaled up volumetrically to larger extruder sizes, the throughput being the cube of the diameter. The economic outlay for a multi-shaft extruder increases with the number of shafts. Therefore, an index that evaluates the economy of a compounding operation using a screw extruder having at least one co-rotating, tightly meshing pair or shafts, taking into account the extruder size, is the volumetric throughput Q (dimension: cubic metres per second) divided by the number N of screw shafts and the cube of the inside diameter of the extruder barrel D (dimension: metres):

$$P = \frac{Q}{N \cdot {D}^{3}} ( standardised volumetric throughput ) .$$

The economy of a process increases as the index P increases. The dimension of the index P is one per second. An index P of at least 0.05/s is generally desirable for an economical compounding process.

The volume flow rate is calculated from the throughput in kg/s, divided by the density of the polymer in the melt phase. If the density of the polymer in the melt phase is not known, 1000 kilograms per cubic metre can be used as a rough estimation.

The throughput with the same number N scales in such a process ideally with the cube of the inside diameter (volumetrically).

In an ideal case, therefore, the throughput can be increased eight-fold by doubling the screw diameter, for example. However, this ideal case requires the extruders to be similar in terms of geometry and energy and all process parameters (for example the residence time, the specific cooling surface and further parameters) to be independent of the extruder size. Unfortunately, however, this is not the case. In particular, the available cooling surface per volume falls as the extruder size increases. The result is that only a process conducted adiabatically or approximately adiabatically (i.e. without heat exchange) on small extruders is comparable with the corresponding process on large production extruders (see, for example, [1] page 223). If the extruder process is carried out approximately adiabatically on relatively small extruders (for example having a screw diameter of about 26 mm), it is possible to scale up the throughput in particular with the cube of the extruder diameter, which leads in the case of large extruder sizes to particularly high throughputs and is therefore particularly economical.

If the process is not carried out adiabatically, the speed must be lowered as the extruder size increases in order to adapt the cooling efficiency to the extruder size, a low speed resulting in an impairment of the economy index P=Q/(N*D³). The dispersing action is also reduced with a lower speed, so that the quality of the compound also suffers.

Accordingly, the high energy input in many processes for incorporating solids into polymers limits the possible throughput of the screw extruder and hence the economy of the process.

Accordingly, starting from the known prior art, the object is to provide a process for incorporating a solid into a polymer or polymer mixture in which the thermal and/or mechanical load is reduced and which consequently permits higher throughputs than the comparable processes described in the prior art.

Surprisingly, it has been found that compounding in twin-screw extruders is possible with very good results even with a markedly lower Lₘₑₗₜ/D ratio of the melt-wetted zone than described according to the prior art. The specific mechanical energy input in the screw extruder is thereby less than 0.25 kWh/kg, so that higher throughputs than described in the prior art can be achieved.

The present invention therefore provides a process for the production of a polymer composite, in which a solid or solids mixture and one or more thermoplastic polymers are mixed in a co-rotating, tightly meshing screw extruder and then extruded, characterised in that the screw extruder has a ratio of the melt-wetted length Lₘₑₗₜ to the barrel inside diameter D in the range from Lₘₑₗₜ/D=4 to Lₘₑₗₜ/D=19, and the index P=Q/(N*D³) is in the range from 0.08 l/s to 1.0 l/s, where Q is the volumetric throughput and N is the number of screw shafts.

A co-rotating, tightly meshing screw extruder is generally understood as being a co-rotating twin- or optionally multi-shaft machine whose screw elements interengage. Such screw extruders with interengaging screws are described in detail in [1].

The process according to the invention is distinguished by a lower Lₘₑₗₜ/D ratio as compared with the prior art. The lower the Lₘₑₗₜ/D ratio, the less energy is introduced into the material for extrusion. A minimum amount of energy must be introduced into the material for extrusion in order to achieve adequate mixing of the solid with the polymer. Surprisingly, it has been found that a lower Lₘₑₗₜ/D ratio than described in the prior art is necessary for adequate mixing of the material for extrusion.

The process according to the invention is distinguished by a maximum Lₘₑₗₜ/D ratio of 19.

The processes known according to the prior art for incorporating solids into polymers are distinguished by higher Lₘₑₗₜ/D ratios.

The Lₘₑₗₜ/D ratio is preferably less than 19, particularly preferably less than 16, most particularly preferably less than 13.

Surprisingly, it has been found that an Lₘₑₗₜ/D ratio of only 4 is in some cases sufficient to achieve adequate mixing of the material for extrusion. Preferably, the Lₘₑₗₜ/D ratio of the process according to the invention is therefore at least 4, preferably at least 5, most particularly preferably at least 6.

The Lₒᵥₑᵣₐₗₗ/D ratio of the screw extruder is, for example, from 1 to 8 times greater than the Lₘₑₗₜ/D ratio. It can, however, also be markedly higher, for example up to Lₒᵥₑᵣₐₗₗ/D=from 40 to 50, especially when an existing extruder having a greater length is used for the process according to the invention. Such an extruder has, for example, a longer solids conveying zone, which does not affect the process according to the invention. Such an extruder can naturally also be used by moving the intake barrel and bridging the superfluous length of the shafts by sleeves, as is shown, for example, in FIG. 4 without explicitly representing the sleeves.

The reduction according to the invention in the Lₘₑₗₜ/D ratio has the advantage that less energy is introduced into the material for extrusion. In addition to an energy saving, this has the advantage that the thermal stress on the material for extrusion is lower.

For an extrusion process conducted adiabatically, the increase in temperature of the product is calculated according to [1] (see pages 116 ft) from the specific energy input. If that is known, the temperature increase can be read off from the enthalpy diagrams known in the literature.

Such enthalpy diagrams are found, for example, in [1] on page 118 and on page 220. The maximum permissible thermal stress of a polymer accordingly determines the permissible specific energy input. The enthalpies are conventionally standardised to zero at room temperature, which at the same time represents the intake temperature of the starting materials into the extruder. If the material streams are warmer or colder when they are fed to the extruder, the person skilled in the art can easily read off the enthalpy difference, for example from an enthalpy diagram, by shifting the zero point. In real processes, the product intake temperatures are in some cases increased as a result of preceding drying operations, which leads to lower specific energy inputs, which are then permissible without subjecting the polymers to excessive thermal stress.

As is known from [1] page 118, as well as from the permissible processing temperatures for the individual polymers known to the person skilled in the art, the permissible energy inputs for adiabatically conducted processes are generally below 0.25 kWh/kg.

The process according to the invention is characterised by the use of a screw extruder having a specific mechanical energy input in the range from 0.1 to 0.25 kWh/kg. The upper value of not more than 0.25 kWh/kg ensures scale-up of the process to a tonne scale, while the lower value of at least 0.1 kWh/kg is necessary for adequate dispersion. The specific mechanical energy input in the screw extruder is preferably in the range from 0.11 to 0.23 kWh/kg, particularly preferably in the range from 0.12 to 0.21 kWh/kg.

Examples of the energy input of processes known in the literature will be found in [1] on page 76, FIG. 4.19. The energy input for the production of “Masterbatch black” is also given here by way of example. It is about 0.3 kWh/kg, which necessarily results in a process that cannot be scaled up volumetrically and is therefore uneconomical for large throughputs. It is also clear from the mentioned figure that the throughput is always lower at higher specific energy inputs, which is attributable to the increase in the temperature of the material for extrusion as the energy input increases and the associated risk of product damage, which increases with the speed of the extruder.

The specific energy input is substantially dependent on the materials used (solid, polymer). It is known that the viscosity of a polymer is increased by the addition of a solid. This is particularly true of the addition of nanoparticles to polymers, for example carbon nanotubes (CNTs).

The increase in viscosity by solids, in particular by nanoparticles, is shown by way of example in FIG. 2 (according to data of Schartel et al., Mechanical, thermal, and fire behavior of Bisphenol A polycarbonate/multiwall carbon nanotube nanocomposites, Polymer Engineering & Science, Vol. 48, No. 1, p. 149-158, 2008, DOI 10.1002/pen.20932) for a polycarbonate melt for multiwalled carbon nanotube (MWCNT) contents of from 0 to 15 wt. %. The pronounced increase in viscosity is not limited to particular polymers or particular fillers such as MWCNTs, however. The melt viscosity increases considerably as a result of solids, and as the solids content increases, the viscosity increases. It is known to the person skilled in the art that the specific mechanical energy input increases as the viscosity increases. Therefore, the specific mechanical energy input increases as the solids content increases.

Because the energy input at a given wetted length of the extruder increases as the viscosity increases, the concept of the short melt-wetted length allows the energy input to be reduced to such an extent that scale-up can take place approximately volumetrically. Accordingly, compounds can be produced economically with fillers that effect a marked increase in viscosity even at a low concentration (e.g. carbon nanotubes). Because the viscosity for high filler concentrations is very high, the process according to the invention is likewise particularly suitable therefor.

Because of the lower Lₘₑₗₜ/D ratio and the accompanying reduced energy input, higher throughputs can be achieved as compared with the prior art and the economy of the process can thus be increased.

The economy is here characterised by the standardised volumetric throughput

P=Q/(N*D³).

The process according to the invention is distinguished by a corresponding index P=Q/(N*D³) in the range from 0.08 l/s to 1.0 l/s, preferably in the range from 0.1 l/s to 0.8 l/s, particularly preferably in the range from 0.12 l/s to 0.6 l/s.

Polymer and solid can be fed to the screw extruder via a common intake. In the coextrusion of carbon nanotubes and polymer, polymer in solid phase is fed together with the carbon nanotubes via the main intake of the screw extruder, so that the CNTs are predispersed in the intake zone by solids friction to form a solids mixture.

It is also possible, however, to feed the polymer to the screw extruder via one intake and to feed the solid via a separate intake. It is possible to melt the polymer wholly or partially between the polymer intake and the solids intake.

The energy required to melt the polymer components is for the most part transmitted via the screw shafts; a flow of heat over the barrel wall serves mainly to form a melt film on the wall. The melt film is important for producing adhesion of the polymer to the wall, whereby a shear gradient can be built up. In order to achieve this, the temperature of the cylinder wall should be above the softening temperature of the polymer.

There is a large number of possible screw configurations for effecting the incorporation according to the invention of solids into polymers in short screws. FIGS. 6a) to f) show some examples of possible screw configurations, these examples not implying any limitation. A very large number of further screw configurations is possible. The configurations shown with degassing zones over side extruders or standard barrels, with different lengths L/D, are intended to illustrate the large variety of possible variants.

Double- or triple-threaded kneading blocks are conventionally used for the plastification. The influence of kneading block geometry on process-related parameters is described by way of example in [1] on pages 65 and 66.

Melting is accelerated in completely filled zones. An accumulation element at the end of the plastification zone is therefore advantageous, in order to effect backing up of the melt. Neutral or reverse-conveying kneading blocks, reverse-conveying threaded elements or slightly reverse-conveying mixing elements are conventionally used for that purpose. Reverse-conveying threaded elements can lead to high pressure and temperature peaks, however, and should be avoided as far as possible. Alternatively, reverse-conveying threads of reduced diameter can also be used.

Screw elements described in applications DE102008029305.9, DE102008029306.7, PCT/EP2009/004250 and PCT/EP2009/004251 are preferably used, because they have particularly small crest angles.

The residence time in the melt phase is preferably in the range from 5 seconds to 120 seconds. Conventional speeds are used for the incorporation of the fillers, which speeds are machine- and process-dependent and are in the range from 60 to 1800 revolutions per minute.

The relationships described above give an interplay between the process parameters, in particular between the Lₘₑₗₜ/D ratio, the parameter P=Q/(N*D³) and the specific energy input, which will be coordinated with one another by a person skilled in the art when carrying out the process according to the invention in order to achieve an optimum result.

A person skilled in the art could, for example, proceed as described hereinbelow:

A conventional task is the production of a masterbatch. The term masterbatch is understood as meaning a mixture of a solid or solids mixture in a polymer or polymer mixture, in which the content of solid is higher than in the final application. This means that a masterbatch is diluted with further polymer before the mixture is used.

A masterbatch should exhibit homogeneous distribution of the solid in the polymer. Homogeneous distribution is understood as meaning that the concentration of solid in a random sample does not differ from the nominal concentration of solid by more than a limit value specified by the application. It could be, for example, that 1 kg of solid is present in 100 kg of mixture (nominal concentration is 1 wt. %). A limit value in the deviation of a random sample of not more than 1% is obtained from the application, for example. A random sample should then have a concentration of solid in the range from 0.99 to 1.01 wt. %.

A person skilled in the art will attempt to keep the Lₘₑₗₜ/D ratio as low as possible in order on the one hand to reduce the energy input and accordingly the risk of product damage, and on the other hand to keep the investment and running costs on operation of the process (e.g. energy costs) low. On the other hand, a minimum energy input is necessary to achieve homogeneous mixing. By means of routine tests or simulations, as are described, for example, in [1] on pages 147 to 168, he will therefore determine the Lₘₑₗₜ/D ratio with which on the one hand homogeneous mixing and on the other hand a minimal energy input can be achieved.

The process according to the invention teaches a person skilled in the art that an Lₘₑₗₜ/D ratio of 19 or less is sufficient to incorporate a solid into a polymer. Depending on the solid and the polymer, there is a lower limit for the Lₘₑₗₜ/D ratio at which homogeneous mixing can still be achieved, which can be determined by a person skilled in the art by routine tests and/or simulations.

It is clear to the person skilled in the art that the Lₘₑₗₜ/D ratio of the melt-wetted zone must be chosen in dependence on the viscosity. In order to lower the energy input to ranges capable of scale-up, the wetted length Lₘₑₗₜ for high viscosities (e.g. caused by particularly high degrees of fill, by nanoparticulate fillers and/or particularly highly viscous polymers) must be particularly short. With a reduced melt-wetted length Lₘₑₗₜ, the torque required for the same throughput is also reduced, and higher throughputs can be achieved, whereby the specific energy input is also reduced.

By means of the process according to the invention it is generally possible to incorporate inorganic and organic fillers into polymers.

There are preferably used as the polymer or polymer mixture thermoplastic polymers, such as, for example, at least one from the group polycarbonate, polyamide, polyester, in particular polybutylene terephthalate and polyethylene terephthalate, polyether, thermoplastic polyurethane, polyacetal, fluorine polymer, in particular polyvinylidene fluoride, polyether sulfone, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene acrylonitrile copolymer, acrylate rubber (ASA), acrylonitrile butadiene styrene block copolymers and polyvinyl chloride.

As the solid or solid mixture there is preferably used at least one solid from the group organic pigments, inorganic pigments, carbon black, carbon nanotubes, silicon dioxide, aluminium oxide, zinc oxide, tin oxide, titanium dioxide, chalk, talc, lime, iron oxide, barium sulfate.

By means of the process according to the invention, which uses extruders having a small melt-wetted length, it is possible to produce in particular also compounds having a higher degree of fill, with degrees of fill of, for example, from 5 to 20 wt. % (but more or less is also possible) with low energy inputs, which permit production also on a large scale (e.g. from 100 to 5000 kg/h). This applies to amorphous polymers (e.g. PC) and in particular also to semi-crystalline polymers (e.g. PA6). Compounds having a filler concentration in the range from 0.5 wt. % to 50 wt. %, preferably in the range from 5 wt. % to 50 wt. %, particularly preferably in the range from 10 wt. % to 50 wt. %, can be produced by the process according to the invention.

The process according to the invention offers the advantage that polymer composites having solids distributed homogeneously in the polymer matrix can be produced in an economically efficient manner on an industrial scale.

In particular, it is possible by means of the process according to the invention to incorporate and homogeneously distribute carbon nanotubes in polymers, and thus produce a polymer composite containing carbon nanotubes. Furthermore, it is possible by means of the process according to the invention to incorporate carbon nanotubes in a relatively high concentration into polymers which are again mixed with polymer at a later stage by the user, that is to say it is possible to prepare a carbon nanotube masterbatch. This procedure has advantages because it avoids open handling of carbon nanotubes by the processor, which can lead to problems with metering and exposure to dust.

The process according to the invention can accordingly be used, for example, in the production of dye masterbatches, carbon black masterbatches or CNT masterbatches. Mutiwalled carbon nanotubes are preferably used in the process according to the invention. Carbon nanotubes having a length to outside diameter ratio of greater than 5, preferably greater than 100, are particularly preferably used.

The carbon nanotubes are used particularly preferably in the form of agglomerates, the agglomerates in particular having a mean diameter in the range from 0.5 to 2 mm. A further preferred process is characterised in that the carbon nanotubes have a mean diameter of from 3 to 100 nm, preferably from 3 to 80 nm. The CNTs known from WO 2006/050903 A2 are particularly preferably used.

The invention further provides a carbon nanotube/polymer composite obtained in the process according to the invention.

The invention also provides the use of the carbon nanotube/polymer composite obtained by the process according to the invention in the production of moulded bodies.

The invention is explained in greater detail hereinbelow with reference to examples and drawings, without being limited thereto.

In the drawings:

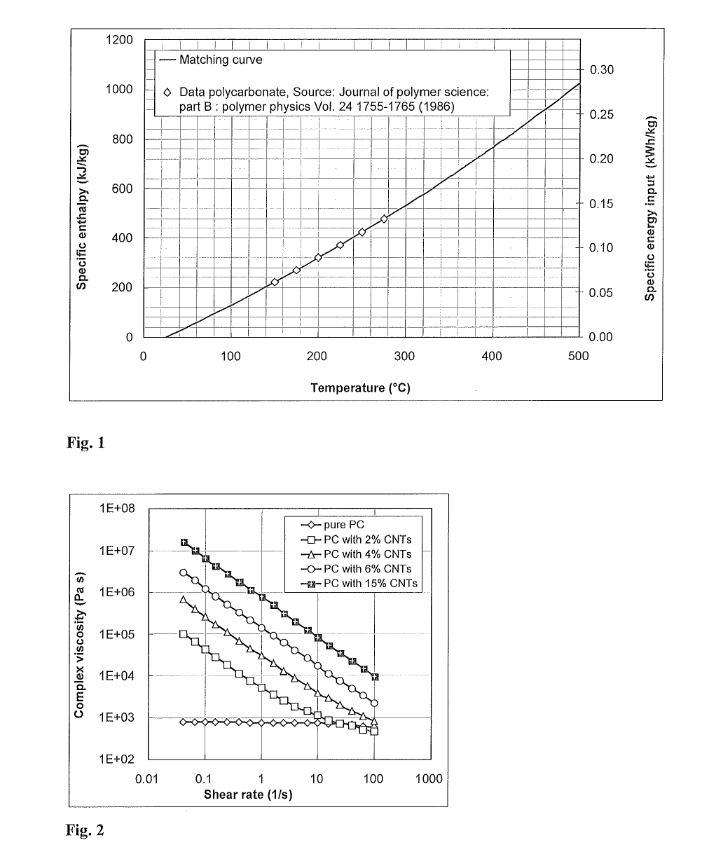

FIG. 1: shows a graph of the specific enthalpy and of the specific energy input of polycarbonate over temperature. The enthalpy and energy input were calculated from the specific heat capacity.

FIG. 2: shows a graph of the complex melt viscosity over the oscillation frequency for polycarbonate (PC) at 260° C., PC with 2 wt. % multiwall carbon nanotubes (MWCNTs), PC with 4 wt. % MWCNTs, PC with 6 wt. % MWCNTs and PC with 15 wt. % CNTs. Data from Schartel et al., Mechanical, thermal, and fire behavior of Bisphenol A polycarbonate/multiwall carbon nanotube nanocomposites, Polymer Engineering & Science, Vol. 48, No. 1, p. 149-158, 2008, DOI 10.1002/pen.20932.

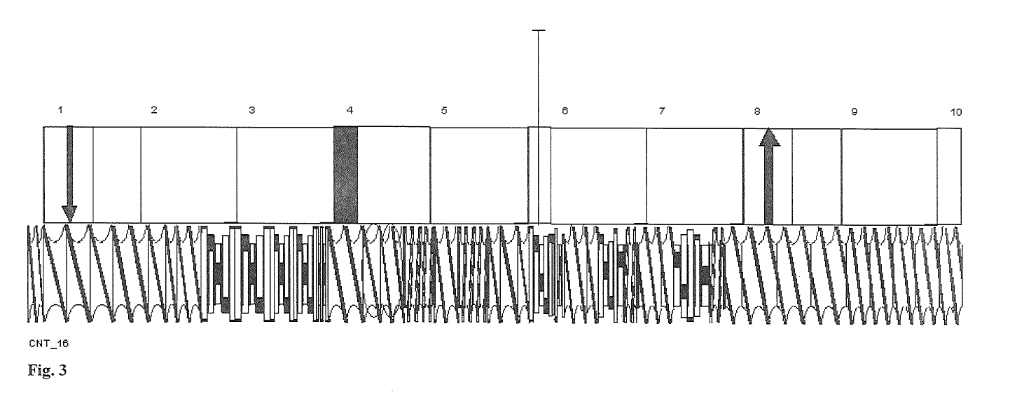

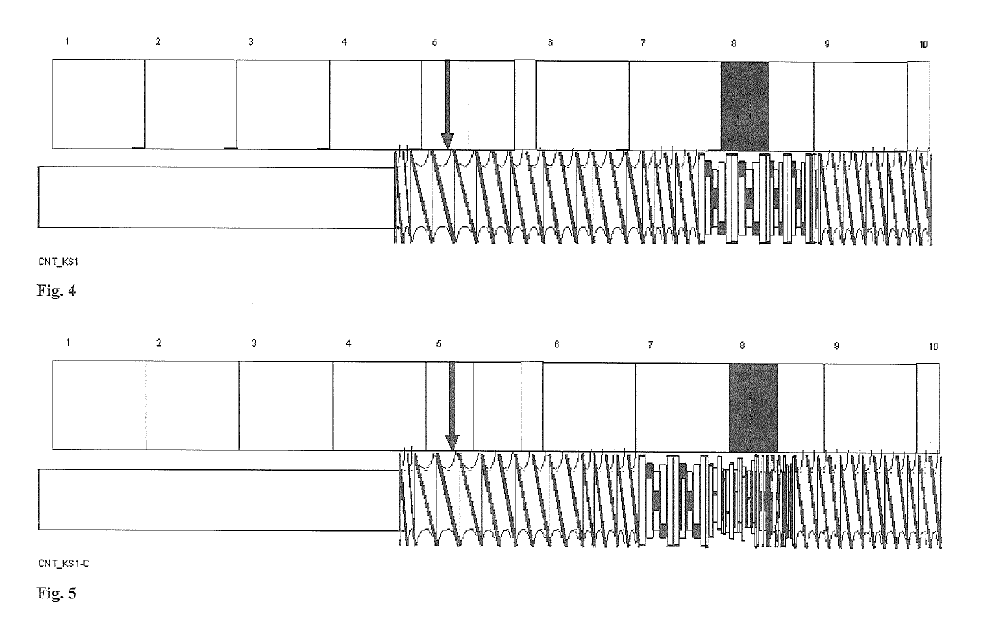

FIG. 3 shows screw fitting CNT16

Lₒᵥₑᵣₐₗₗ is 9.5 barrels, i.e. 950 mm; with screw diameter D=25.7 mm this gives an Lₒᵥₑᵣₐₗₗ/D ratio of 37. The melt-wetted length is Lₘₑₗₜ=788 mm, so that an Lₘₑₗₜ/D ratio of 30.7 is obtained.

FIG. 4: shows screw fitting KS1 Lₒᵥₑᵣₐₗₗ from the intake barrel is 5.5 barrels, i.e. 550 mm; with screw diameter D=25.7 mm this gives an Lₒᵥₑᵣₐₗₗ/D ratio of 21.4. Because the existing long screw shafts are to be used for the short structure, the excess length of the shafts was bridged by barrels 1-4, the screws in this region were provided with sleeves. The actual process part begins with the intake barrel (barrel with downward arrow). The melt-wetted length is Lₘₑₗₜ=252 mm, so that an Lₘₑₗₜ/D ratio of 9.8 is obtained.

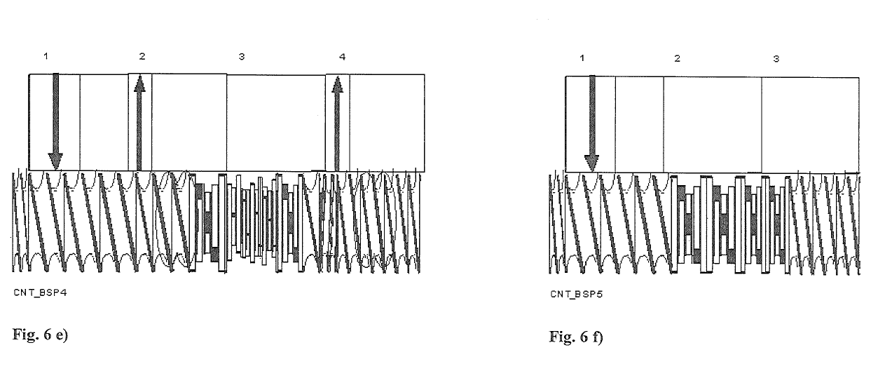

FIG. 5: Screw fitting KS1-C

Lₒᵥₑᵣₐₗₗ from the intake barrel is 5.5 barrels, i.e. 550 mm; with screw diameter D=25.7 mm this gives an Lₒᵥₑᵣₐₗₗ/D ratio of 21.4. Because, as in the case of screw fitting KS1, the existing long screw shafts are to be used for the short structure, the excess length of the shafts was bridged by barrels 1-4, the screws in this region were provided with sleeves. The actual process part begins with the intake barrel (barrel with downward arrow). The melt-wetted length is Lₘₑₗₜ=323 mm, so that an Lₘₑₗₜ/D ratio of 12.6 is obtained.

FIG. 6: shows examples of fittings for producing, by way of example, the short process length of the melt-wetted zone according to the invention

a) fitting 1

b) fitting 2

c) fitting 3

d) fitting 4

e) fitting 5

### EXAMPLES FROM THE PRIOR ART

### Not According to the Invention

Table 1 shows the results of the implementation examples from WO2009/00408A1. For the screw extruder used therein, two standard barrels are indicated for the intake zone, two standard barrels for the melting zone, from at least one to a maximum of three standard. barrels for the after-dispersion, which can be supplemented with a further short barrel, one standard barrel for a degassing zone and one standard barrel for the pressure build-up zone. The length of the standard barrel for the listed extruder type ZSK 26Mc (Coperion Werner & Pfleiderer) is 100 mm, a short barrel of the mentioned extruder is 25 mm long. The inside diameter of the extruder barrel D for the ZSK 26Mc type extruder (Coperion Werner & Pfleiderer) is 25.7 mm. Consequently, the overall length to the product outlet is from 700 mm to 925 mm. There is thus obtained for the screw extruder and for the process a characteristic overall length having an Lₒᵥₑᵣₐₗₗ/D ratio of from 27.2 to 36.0. Because two standard barrels are indicated for the intake zone, the melt-wetted length, which is here defined as the length from the start of the melting zone (first kneading block) to the end of the extruder shafts, is obtained by subtracting the length of the intake zone from the overall length. The melt-wetted length is accordingly from 500 mm to 725 mm, which corresponds to a length with an Lₘₑₗₜ/D ratio in the range from 19.5 to 28.2. Because the energy inputs indicated in WO2009/00408A1 are high, see Table 1, the L/D ratios actually used should in fact be in the upper range indicated.

TABLE 1
Comparison examples, not according to the invention, from WO2009/00408A1,
wherein the overall extruder length has an Lₒᵥₑᵣₐₗₗ/D ratio in the range from 27.2 to 36 and
the melt-wetted length has an Lₘₑₗₜ/D ratio of from 19.5 to 28.2. The type ZSK 26Mc
extruder has a number of shafts N equal to two, and the density of the melt was taken as
1020 kg/m³ for polycarbonate (PC), 1105 kg/m³ for polybutylene terephthalate (PBT) and
970 kg/m³ for polyamide 6 (PA6).

| | | | | | Specific | | |
|---|---|---|---|---|---|---|---|
| | | CNT | | | mechanical | Volume | Index |
| | | content | Throughput | Speed | energy input | flow rate Q | Q/(N * D³) |
| Test number | Polymer | wt. % | kg/h | 1/min | kWh/kg | m³/h | 1/s |
| 1 | PC | 0.2 | 18 | 400 | 0.2977 | 0.0176 | 0.144 |
| 2 | PC | 0.2 | 25 | 600 | 0.3133 | 0.0245 | 0.201 |
| 3 | PC | 0.2 | 18 | 400 | 0.2901 | 0.0176 | 0.144 |
| 4 | PC | 0.2 | 25 | 600 | 0.3133 | 0.0245 | 0.201 |
| 5 | PC | 2 | 26 | 400 | 0.2630 | 0.0255 | 0.209 |
| 6 | PC | 3 | 26 | 400 | 0.2562 | 0.0255 | 0.209 |
| 7 | PC | 5 | 24 | 400 | 0.2849 | 0.0235 | 0.193 |
| 8 | PC | 7.5 | 22 | 400 | 0.3148 | 0.0216 | 0.176 |
| 9 | PC | 5 | 24 | 400 | 0.2849 | 0.0235 | 0.193 |
| 10 | PC | 5 | 27 | 600 | 0.2960 | 0.0265 | 0.217 |
| 11 | PC | 5 | 18 | 600 | 0.3848 | 0.0176 | 0.144 |
| 12 | PC | 5 | 9 | 600 | 0.5920 | 0.0088 | 0.072 |
| 13 | PC | 5 | 3 | 200 | 0.7252 | 0.0029 | 0.024 |
| 14 | PBT | 2 | 15 | 400 | 0.4440 | 0.0136 | 0.111 |
| 15 | PBT | 3 | 17 | 400 | 0.3917 | 0.0154 | 0.126 |
| 16 | PBT | 5 | 19 | 400 | 0.3692 | 0.0172 | 0.141 |
| 17 | PBT | 7.5 | 19 | 400 | 0.3692 | 0.0172 | 0.141 |
| 18 | PA6 | 3 | 24 | 400 | 0.2812 | 0.0247 | 0.202 |
| 19 | PA6 | 5 | 22 | 400 | 0.3027 | 0.0227 | 0.186 |
| 20 | PA6 | 7.5 | 21 | 400 | 0.3213 | 0.0216 | 0.177 |

Table 2 shows, by way of example, the very low throughputs in the range of from 3.6 to 9.1 kg/h according to the prior art (WO1994/023433A1) in the production of compounds filled with carbon nanotubes with degrees of fill in the range from 5 to 15 wt. %. The values of the index Q/(N*D³) are in the range from 0.019 to 0.048 l/s and are therefore in the uneconomical range both for amorphous polymers (here polycarbonate, for example) and for semi-crystalline polymers (here polyamide 6, for example).

TABLE 2
Comparison examples, not according to the invention, from WO1994/023433A1,
wherein the overall extruder length L_overall/D, the melt-wetted length L_melt/D and the
specific energy input are not known; the number of shafts N is in each case two.

| | | CNT | | Extruder | Melt | | | Volume | Index |
|---|---|---|---|---|---|---|---|---|---|
| | | content | | diameter D | density | Throughput | Speed | flow rate Q | Q/(N * D³) |
| Example | Polymer | wt. % | Machine | mm | kg/m³ | kg/h | 1/min | m³/h | 1/s |
| 2A | PA6 | 5 | ZSK-30 | 30 | 970 | 6.8 | 115 | 0.0070 | 0.036 |
| 2A | PA6 | 5 | ZSK-30 | 30 | 970 | 9.1 | 115 | 0.0094 | 0.048 |
| 2B | PA6 | 15 | ZSK-30 | 30 | 970 | 3.6 | 115 | 0.0037 | 0.019 |
| 2B | PA6 | 15 | ZSK-30 | 30 | 970 | 5.0 | 115 | 0.0051 | 0.026 |
| 3B | PC | 10 | ZSK-30 | 30 | 1020 | 4.1 | 150-200 | 0.0040 | 0.021 |
| 3B | PC | 10 | ZSK-30 | 30 | 1020 | 6.8 | 150-200 | 0.0067 | 0.034 |
| 5B | PC | 15 | ZSK-30 | 30 | 1020 | 5.4 | 150-175 | 0.0053 | 0.027 |
| 5B | PC | 15 | ZSK-30 | 30 | 1020 | 6.8 | 150-175 | 0.0067 | 0.034 |

### OWN EXAMPLES

### Not According to the Invention

The examples, not according to the invention, of compounds with filler contents of from 15 to 20 wt. % in Table 3 show that the specific energy input is very high (values above 0.5 kWh/kg) with extruder lengths according to the prior art. This results in a high requirement for cooling capacity, which limits the throughput. As a result, the index Q/(N*D³) assumes low values (values up to a maximum of 0.08 l/s) and the process becomes uneconomical. In the examples in Table 3, it was not possible to operate the extruder adiabatically; the barrels had to be cooled considerably. If larger extruders are used, even these low values of the index Q/(N*D³) cannot be achieved without damaging the product through impermissibly high temperatures, because of the lower specific cooling surface.

As polymers there were used polycarbonate (PC), commercial products: Makrolon® 2600 [PC2600], Makrolon® 2608 [PC2608] and Makrolon® 2805 [PC2805], manufacturer in each case Bayer MaterialScience AG.

The following commercial products were used as solids: Baytubes® C150P and Baytubes® C150HP (CNTs produced by catalytic gas-phase deposition according to WO 2006/050903 A2), manufacturer: Bayer MaterialScience AG, Nanocyl™ NC7000, manufacturer: Nanocyl SA.

TABLE 3
Own examples, not according to the invention, wherein the overall extruder length Lₒᵥₑᵣₐₗₗ/D is 37.0 and the melt-wetted length Lₘₑₗₜ/D
is 30.7. The tests were carried out on a twin-shaft screw extruder of the type ZSK 26Mc (Coperion Werner & Pfleiderer) with barrel cooling.
Fitting CNT16 was used as the screw fitting. The density of polycarbonate of 1020 kg/m³ was used as the density of the melt for the
compound.

| | | | | | | Specific mechanical | | |
|---|---|---|---|---|---|---|---|---|
| | | CNT content | | Throughput | Speed | energy input | Volume flow rate Q | Index Q/(N * D³) |
| Test number | Polymer | wt. % | Filler | kg/h | 1/min | kWh/kg | m³/h | 1/s |
| PC-5 | PC2608 | 15 | Baytubes ® | 11.8 | 400 | 0.5661 | 0.0115 | 0.094 |
| | | | C 150 P | | | | | |
| PC-7 | PC2600 | 20 | Baytubes ® | 10 | 400 | 0.7371 | 0.0098 | 0.080 |
| | | | C 150 HP | | | | | |
| PC-8 | PC2600 | 20 | Nanocyl ™ | 7.5 | 400 | 0.9946 | 0.0074 | 0.060 |
| | | | NC7000 | | | | | |
| PC-9 | PC2600 | 15 | Nanocyl ™ | 7.1 | 400 | 0.8177 | 0.0069 | 0.057 |
| | | | NC7000 | | | | | |

### OWN EXAMPLES

### According to the Invention

### Example 1

The incorporation of multiwalled carbon nanotubes (commercial product: Baytubes® C150P (CNTs produced by catalytic gas-phase deposition according to WO 2006/050903 A2), manufacturer: Bayer MaterialScience AG) into polycarbonate (PC) (commercial product: Makrolon® 2805 [PC2805], manufacturer: Bayer MaterialScience AG) is carried out on a twin-shaft screw extruder of type ZSK 26Mc (Coperion Werner & Pfleiderer). In the tests, both the polymer granules and the CNTs are metered into the extruder via the main intake.

The process parameters are shown in Table 4 below. The barrels of the extruder, with the exception of the intake barrel, were not cooled in order to operate the extruder approximately adiabatically. In order to rule out premature melting in the intake barrel by thermal conduction, the intake barrel was adjusted to a temperature of 60° C.

The specific mechanical energy input is calculated by means of the following equation: Specific mechanical energy input=2*π*speed*torque of the shafts/throughput.

The economy is calculated by means of the following index: Economy index=throughput/(number of shafts*extruder diameter̂3). With achieved values of this index in the range of from 0.102 to 0.467 l/s, the process according to the invention is markedly more economical, especially since the low energy inputs of from 0.169 to a maximum of 0.222 kWh/kg permit an approximately adiabatic procedure and accordingly allow the procedure to be transferred to larger extruders.

TABLE 4
Example 1 according to the invention, wherein the overall extruder length Lₒᵥₑᵣₐₗₗ/D for the screw fitting
KS1 used (see FIG. 4) is 21.4 and the melt-wetted length Lₘₑₗₜ/D is 9.8. The tests were conducted on a twin-shaft
screw extruder of the type ZSK 26Mc (Coperion Werner & Pfleiderer), only the intake barrel being adjusted to a
temperature of 60° C. None of the other barrels was cooled, in order to operate the extruder virtually adiabatically.
For the tests with polycarbonate, the melt density of polycarbonate of 1020 kg/m³ was used as the density for the
compound. Baytubes ® C150P was incorporated as filler into the polycarbonate.

| | | | | Specific mechanical | | |
|---|---|---|---|---|---|---|
| | CNT content | Throughput | Speed | energy input | Volume flow rate Q | Index Q/(N * D³) |
| Test number | wt. % | kg/h | 1/min | kWh/kg | m³/h | 1/s |
| PC-KS03 | 20.0 | 20.0 | 400.0 | 0.218 | 0.0196 | 0.160 |
| PC-KS04 | 20.0 | 29.0 | 500.0 | 0.218 | 0.0284 | 0.233 |
| KS1-PC1 | 3.0 | 15.0 | 500.0 | 0.218 | 0.0147 | 0.120 |
| KS1-PC2 | 5.0 | 15.0 | 500.0 | 0.222 | 0.0147 | 0.120 |
| KS1-PC3 | 7.5 | 15.0 | 500.0 | 0.222 | 0.0147 | 0.120 |
| KS1-PC4 | 5.0 | 68.4 | 800.0 | 0.169 | 0.0671 | 0.549 |

### Example 2

The incorporation of multiwalled carbon nanotubes (commercial product: Baytubes® C150P and Baytubes® C150HP (CNTs produced by catalytic gas-phase deposition according to WO 2006/050903 A2), manufacturer: Bayer MaterialScience AG) into polyamide 6 (PA6) (commercial product: Durethan® B29, manufacturer: LANXESS Deutschland GmbH) is carried out on a twin-shaft screw extruder of the type ZSK 26Mc (Coperion Werner & Pfleiderer). In the tests, both the polymer granules and the CNTs are metered into the extruder via the main intake.

The process parameters are shown in Table 5 below. The barrels of the extruder, with the exception of the intake barrel, were not cooled, in order to operate the extruder approximately adiabatically. In order to rule out premature melting in the intake barrel by thermal conduction, the intake barrel was adjusted to a temperature of 60° C.

The melt temperature is measured with a commercial temperature sensor directly in the melt strand emerging from the die plate.

The specific mechanical energy input is calculated by means of the following equation:

Specific mechanical energy input=2*π*speed*torque of the shafts/throughput.

The economy is calculated by means of the following index:

Economy index=throughput/(number of shafts*extruder diameter̂3).

Dilution of highly concentrated compounds took place in the following tests: In test PA6-KS08, the highly concentrated compound (20 wt. %) from test PA6-KSO4/02 was diluted to 5 wt. %. In the following tests, 15 wt. % compounds were diluted to 5 wt. %: In test PA6-KS17, the compound prepared in test PA6-KS13; in test PA6-KS18, the compound prepared in test PA6-KS14; in test PA6-KS19, the compound prepared in test PA6-KS15, and in test PA6-KS20, the compound prepared in test PA6-KS16.

TABLE 5
Example 2 according to the invention, wherein the overall extruder length Lₒᵥₑᵣₐₗₗ/D for the screw fitting KS1-C
used (see FIG. 5) is 21.4. Fitting KS1-C has a melt- wetted length Lₘₑₗₜ/D of 12.6. The tests were carried out on a
twin-shaft screw extruder of the type ZSK 26Mc (Coperion Werner & Pfleiderer), only the intake barrel being adjusted
to a temperature of 60° C. None of the other barrels was cooled, in order to operate the extruder virtually adiabatically.
In all the tests, polyamide 6 (PA6, commercial product: Durethan ® B29, manufacturer: LANXESS Deutschland GmbH) was
used as the polymer. The melt density of polyamide 6 of 970 kg/m³ was used as the density for the compound.
Baytubes ® having the type designations C150P and C150HP (manufacturer: Bayer MaterialScience AG; produced by catalytic
gas-phase deposition according to WO 2006/050903 A2) were used as the solid (filler).

| | | | | | Specific mechanical | | |
|---|---|---|---|---|---|---|---|
| | CNT content | | Throughput | Speed | energy input | Volume flow rate Q | Index Q/(N * D³) |
| Test number | wt. % | Filler | kg/h | 1/min | kWh/kg | m³/h | 1/s |
| PA6-KS13 | 15.0 | C150P | 11.8 | 338.0 | 0.217 | 0.0121 | 0.099 |
| PA6-KS14 | 15.0 | C150P | 23.5 | 340.0 | 0.143 | 0.0243 | 0.198 |
| PA6-KS15 | 15.0 | C150P | 20.0 | 324.0 | 0.171 | 0.0206 | 0.169 |
| PA6-KS16 | 15.0 | C150P | 40.0 | 600.0 | 0.225 | 0.0412 | 0.337 |
| PA6-KS04/2 | 20.0 | C150P | 30.0 | 460.0 | 0.218 | 0.0309 | 0.253 |
| PA6-KS08 | 5.0 | C150P | 56.0 | 800.0 | 0.192 | 0.0577 | 0.472 |
| PA6-KS17 | 5.0 | C150P | 42.0 | 600.0 | 0.192 | 0.0433 | 0.354 |
| PA6-KS18 | 5.0 | C150HP | 42.0 | 600.0 | 0.190 | 0.0433 | 0.354 |
| PA6-KS19 | 5.0 | C150P | 42.0 | 600.0 | 0.182 | 0.0433 | 0.354 |
| PA6-KS20 | 5.0 | C150P | 42.0 | 600.0 | 0.181 | 0.0433 | 0.354 |
| PA6-61-KS1 | 3.0 | C150P | 15.0 | 500.0 | 0.226 | 0.0155 | 0.127 |
| PA6-62-KS1 | 3.0 | C150P | 15.0 | 500.0 | 0.226 | 0.0155 | 0.127 |

1. Process for the production of a polymer composite, in which at least one solid or solids mixture and one or more thermoplastic polymers are mixed in a co-rotating, tightly meshing screw extruder and then extruded, characterised in that the screw extruder has a ratio of the melt-wetted length Lₘₑₗₜ to the barrel inside diameter D of the screw extruder in the range from Lₘₑₗₜ/D=4 to Lₘₑₗₜ/D=19, and the standardised volumetric throughput Q/(N*D³) is in the range from 0.08 l/s to 1.0 l/s, wherein Q is the volumetric throughput and N is the number of screw shafts.

2. Process according to claim 1, characterised in that the Lₘₑₗₜ/D ratio is less than 19, particularly preferably less than 16, most particularly preferably less than 13.

3. Process according to claim 1, characterised in that the Lₘₑₗₜ/D ratio of the process according to the invention is at least 4, preferably at least 5, most particularly preferably at least 6.

4. Process according to claim 1, characterised in that the standardised volumetric throughput Q/(N*D³) is in the range from 0.1 l/s to 0.8 l/s, preferably in the range from 0.12 l/s to 0.6 l/s.

5. Process according to claim 1, characterised in that the specific energy input is in the range from 0.1 to 0.25 kWh/kg, preferably in the range from 0.11 to 0.23 kWh/kg, particularly preferably in the range from 0.12 to 0.21 kWh/kg.

6. Process according to claim 1, characterised in that the solid is inorganic fillers and/or organic fillers with a filler concentration in the range from 0.5 wt. % to 50 wt. %, preferably in the range from 5 wt. % to 50 wt. %, particularly preferably in the range from 10 wt. % to 50 wt. %.

7. Process according to claim 1, characterised in that at least a portion of the solids is added via at least one side extruder and/or degassing is carried out via at least one side extruder.

8. Process according to claim 1, characterised in that multiwalled carbon nanotubes are used as the solid.

9. Process according to claim 1, characterised in that carbon nanotubes having a ratio of length to outside diameter of greater than 5, preferably greater than 100, are used as the solid.

10. Process according to claim 1, characterised in that agglomerates of carbon nanotubes are used as the solid.

11. Process according to claim 1, characterised in that carbon nanotubes having a mean diameter of from 3 to 100 nm, preferably from 3 to 80 nm, are used as the solid.

12. Process according to claim 1, characterised in that the thermoplastic polymer is at least one from the group polycarbonate, polyamide, polyester, in particular polybutylene terephthalate and polyethylene terephthalate, polyether, thermoplastic polyurethane, polyacetal, fluorine polymer, in particular polyvinylidene fluoride, polyether sulfone, polyolefin, in particular polyethylene and polypropylene, polyimide, polyacrylate, in particular poly(methyl)methacrylate, polyphenylene oxide, polyphenylene sulfide, polyether ketone, polyaryl ether ketone, styrene polymers, in particular polystyrene, styrene copolymers, in particular styrene acrylonitrile copolymer, acrylate rubber (ASA), acrylonitrile butadiene styrene block copolymers and polyvinyl chloride.

13. Carbon nanotube/polymer composite obtained in a process according to claim 1.

14. Use of the carbon nanotube/polymer composite according to claim 12 in the production of moulded bodies.
